(19) United States
(12) Patent Application Publication
(10) Pub. No.: US 2012/0063269 A1
(43) Pub. Date: Mar. 15, 2012

(54) ROTARY TYPE DISTANCE ESTIMATION APPARATUS AND MOVING BODY INCLUDING THE SAME

(75) Inventor: Hakyoung Chung, Seoul (KR)

(73) Assignee: MICROINFINITY, INC., Gyeonggi-do (KR)

(21) Appl. No.: 13/086,707

(22) Filed: Apr. 14, 2011

(30) Foreign Application Priority Data
Sep. 14, 2010 (KR) 10-2010-0090091

(51) Int. Cl. G01S 3/80; G01C 3/08

(52) U.S. Cl. 367/118; 356/4.01; 250/338.1

(57) ABSTRACT

Provided is a rotary type distance estimation apparatus. The rotary type distance estimation apparatus includes: a signal transmission unit transmitting a signal for measuring a distance to an obstacle; a signal reception unit receiving the signal reflected by the obstacle; a distance calculation unit calculating the distance to the obstacle by processing the received signal; a rotation unit rotating a direction of the signal transmitted from the signal transmission unit; and a determination unit determining the direction of the signal within a predetermined angle range according to what number of times the received signal matches based on a rotation angle per sampling of the signal.

### RELATED APPLICATION

This application claims priority from Korean Patent Application No. 10-2010-0090091 filed on Sep. 14, 2010, the disclosure of which is incorporated herein by reference in its entirety.

### BACKGROUND OF THE INVENTION

1. Field of the Invention

The present invention relates to a rotary type distance estimation apparatus and a moving body including the same, and more particularly, to a rotary type distance estimation apparatus which can measure the distance to an obstacle by identifying a rotation angle without installing an additional device and a moving body including the rotary type distance estimation apparatus.

2. Description of the Related Art

A mobile robot used in homes and offices, such as a cleaning robot or a security robot, needs to generate an obstacle map in order to determine a path along which it is to move or a section in which it is to carry out its activities and in order to move in the section without colliding with obstacles.

To generate an obstacle map, a mobile robot measures its distances to obstacles using a distance estimation apparatus while autonomously moving in a region. Based on the measured distance data, the mobile robot generates an obstacle map.

A rotary type distance estimation apparatus is used to measure distances to obstacles. The rotary type distance estimation apparatus does not just measure the distance to an obstacle in a certain direction from a direction in which a mobile robot is traveling. It is a sensor that measures the distances to obstacles within a predetermined angle range with respect to the travelling direction of the mobile robot.

More specifically, a rotary type distance estimation apparatus transmits a signal for measuring the distance to an obstacle not only in a certain direction but also at various angles. Therefore, the distances to obstacles within a predetermined angle range can be measured. For example, a rotary type laser distance estimation sensor (a laser scanner) installed in a mobile robot senses a distance between the mobile robot and an obstacle by transmitting a laser signal to the obstacle while rotating with a uniform velocity and receiving the laser signal reflected by the obstacle. In this way, if obstacles are continuously sensed, an obstacle map for the entire region in which the mobile robot moves can be generated. Here, to sense obstacles and generate an obstacle map, it is required to accurately identify a direction in which(an angle at which) a laser signal is transmitted.

A conventional rotary type distance estimation sensor identifies the angle at which its signal is transmitted (i.e., an angle of a rotary device) using an additional device such as an encoder or a gyroscope installed in the rotary device that transmits a signal at various angles. However, installing such an additional device to identify the angle at which a signal is transmitted increases the cost of a mobile robot. Therefore, a method of identifying the angle at which a signal is transmitted without using an additional device is required.

### SUMMARY OF THE INVENTION

Aspects of the present invention provide a rotary type distance estimation apparatus which can identify a direction in which(an angle at which) a signal is transmitted without installing an additional device such as an encoder in a rotary device thereof.

Aspects of the present invention also provide a moving body which can generate an obstacle map using the rotary type distance estimation apparatus installed therein.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a rotary type distance estimation apparatus including: a signal transmission unit transmitting a signal for measuring a distance to an obstacle; a signal reception unit receiving the signal reflected by the obstacle; a distance calculation unit calculating the distance to the obstacle by processing the received signal; a rotation unit rotating a direction of the signal transmitted from the signal transmission unit; and a determination unit calculating a rotation angle per sampling using a number of times that the signal received by the signal reception unit is sampled while the signal is transmitted within a predetermined angle range using the rotation unit and determining the direction of the signal based on the calculated rotation angle per sampling.

According to another aspect of the present invention, there is provided a moving body including a sensor which senses obstacles and generating an obstacle map while autonomously travelling around, wherein the sensor includes: a signal transmission unit transmitting a signal for measuring a distance to an obstacle; a signal reception unit receiving the signal reflected by the obstacle; a distance calculation unit calculating the distance to the obstacle by processing the received signal; a rotation unit rotating a direction of the signal transmitted from the signal transmission unit; and a determination unit calculating a rotation angle per sampling using a number of times that the signal received by the signal reception unit is sampled while the signal is transmitted within a predetermined angle range using the rotation unit and determining the direction of the signal based on the calculated rotation angle per sampling.

### BRIEF DESCRIPTION OF THE DRAWINGS

The above and other aspects and features of the present invention will become more apparent by describing in detail exemplary embodiments thereof with reference to the attached drawings, in which:

FIG. 1 is a diagram illustrating a mobile robot located in a region having obstacles;

FIG. 2 is a diagram illustrating an obstacle map generated by the mobile robot in the region of FIG. 1;

FIG. 3 is a diagram illustrating the configuration of a rotary type distance estimation apparatus according to an exemplary embodiment of the present invention;

FIG. 4 is a diagram illustrating an effective angle range of the rotary type distance estimation apparatus; and

FIG. 5 is a diagram illustrating a situation where a mobile robot according to an exemplary embodiment of the present invention measures its distance to an obstacle using the rotary type distance estimation apparatus while moving around in a region.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Embodiments of the invention are described herein with reference to plan and cross-section illustrations that are schematic illustrations of idealized embodiments of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

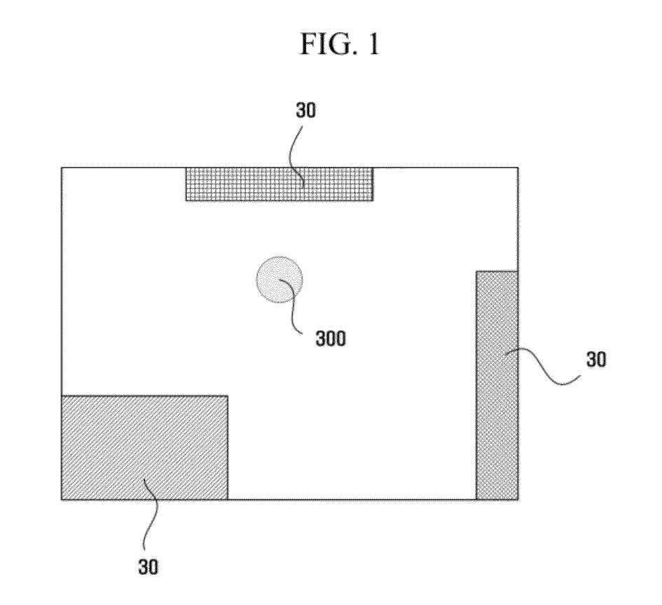

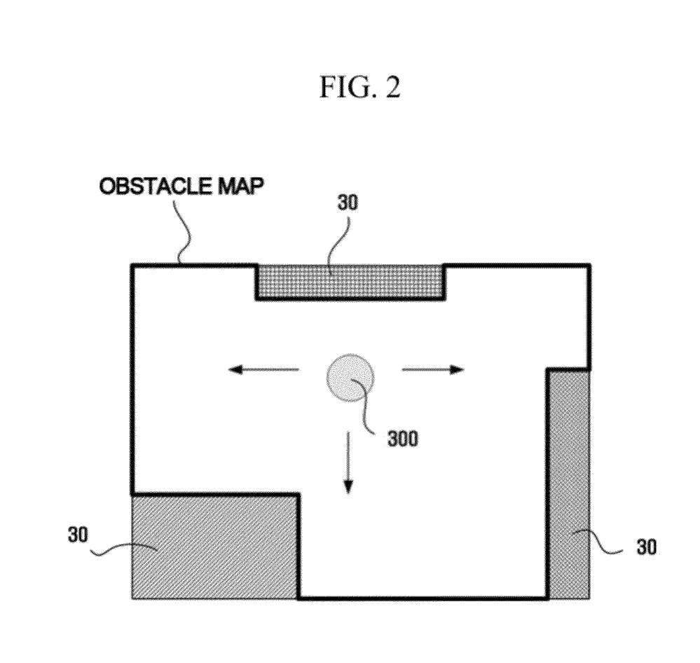

FIG. 1 is a diagram illustrating a mobile robot 300 located in a region having obstacles 30. FIG. 2 is a diagram illustrating an obstacle map generated by the mobile robot 300 in the region of FIG. 1.

In FIG. 1, a region such as a room in which the mobile robot 300 is travelling is illustrated. Within the region, the obstacles 30 such as a desk and a wardrobe may be located. When the mobile robot 300 such as a cleaning robot or a security robot first enters the region, it should generate an obstacle map in order to identify the space in which it can move around. The obstacle map is a map of a space in which the mobile robot 300 can move around in the region and is generated by connecting walls and the obstacles 30 (the walls can also be considered as obstacles) excepting the walls in the region.

While traveling within the region, the mobile robot 300 may continuously measure its distances from the obstacles 30 and generate the obstacle map based on the measured distances. In FIG. 2, the obstacle map generated by the mobile robot 300 based on the measured distances is illustrated. The mobile robot 300 can identify locations to which it can move to in the obstacle map and can autonomously move around based on the identified locations.

To calculate its distances from the obstacles 30, the mobile robot 300 may be equipped with a rotary type distance estimation apparatus.

As described above, the rotary type distance estimation apparatus does not just measure the distance to an obstacle in a certain direction from the mobile robot 300. Instead of transmitting a signal for measuring the distance to an obstacle only in a certain direction, the rotary type distance estimation apparatus transmits the signal by continuously changing the transmission direction of the signal. Therefore, the rotary type distance estimation apparatus is a distance measurement sensor that can measure the distances to all obstacles in directions in which the signal is transmitted.

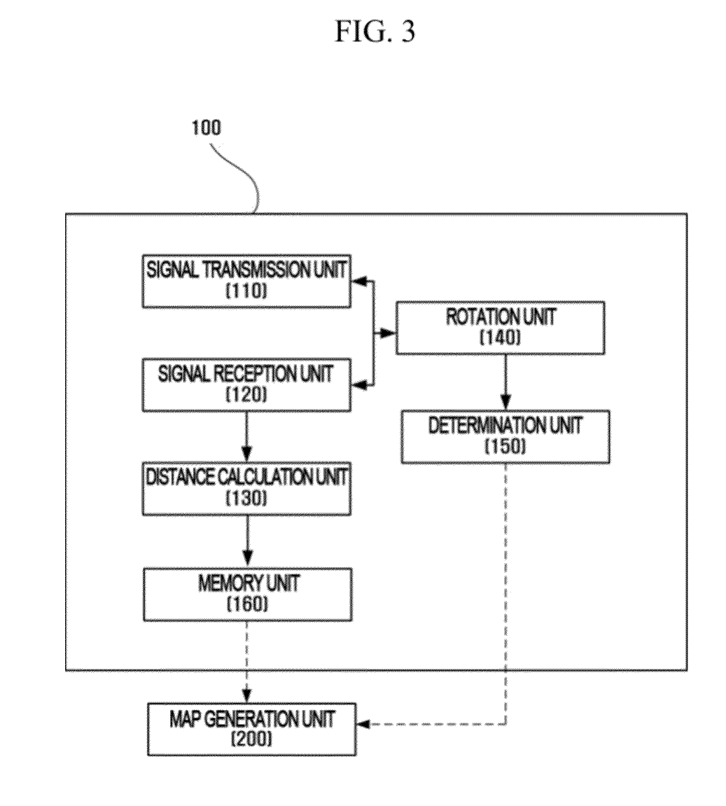

Hereinafter, a rotary type distance estimation apparatus according to an exemplary embodiment of the present invention will be described with reference to FIGS. 3 through 5.

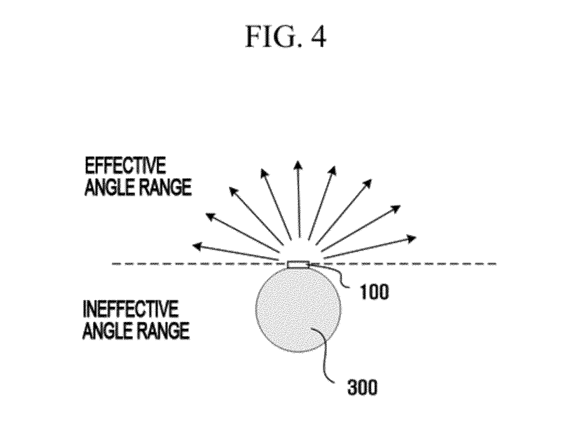

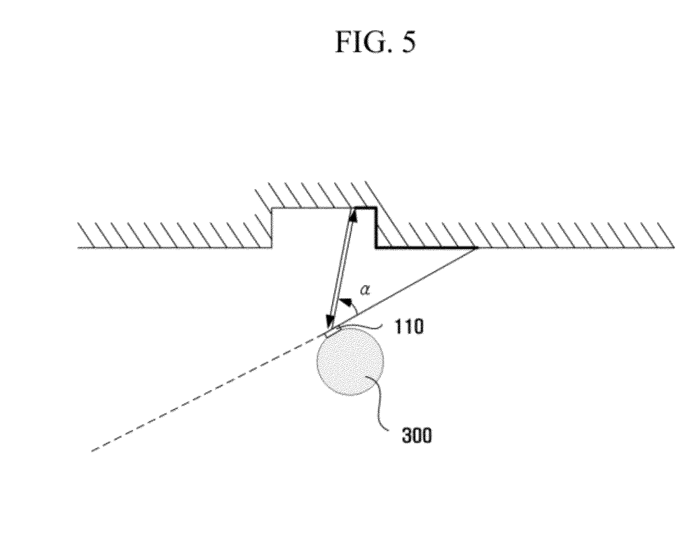

FIG. 3 is a diagram illustrating the configuration of a rotary type distance estimation apparatus 100 according to an exemplary embodiment of the present invention. FIG. 4 is a diagram illustrating an effective angle range of the rotary type distance estimation apparatus 100. FIG. 5 is a diagram illustrating a situation where a mobile robot 300 according to an exemplary embodiment of the present invention measures its distance to an obstacle using the rotary type distance estimation apparatus 100 while moving around in a region.

The rotary type distance estimation apparatus 100 according to the current exemplary embodiment may include a signal transmission unit 110, a signal reception unit 120, a distance calculation unit 130, a rotation unit 140, and a determination unit 150. The rotary type distance estimation apparatus 100 may further include a memory unit 160.

The signal transmission unit 110 transmits a signal for measuring the distance to an obstacle, and the signal reception unit 120 receives the signal transmitted to the obstacle from the signal transmission unit 110 and then reflected by the obstacle. Here, examples of the signal transmitted and received respectively by the signal transmission unit 110 and the signal reception unit 120 may include a laser signal, an ultrasonic signal, and an infrared (IR) signal. In the present invention, the signal reception unit 120 receives the signal at predetermined time intervals. The time intervals at which the signal reception unit 120 receives the signal will hereinafter be referred to as sampling time.

The distance calculation unit 130 processes the signal received by the signal reception unit 120 and calculates the distance to the obstacle based on the processed signal. To measure the distance to the obstacle using the received signal, the time taken for the signal transmitted from the signal transmission unit 110 to arrive at the signal reception unit 120 after being reflected by the obstacle and the speed of the signal may be used, or triangulation may be used. That is, the distance to the obstacle may be measured using various known methods according to the type of the signal.

The rotation unit 140 rotates the direction of the signal transmitted from the signal transmission unit 110. As described above, the present invention relates to a rotary type distance estimation apparatus. Therefore, the rotation unit 140 rotates the direction of the signal transmitted from the signal transmission unit 110, so that distances to obstacles not only in a certain direction but also within a predetermined angle range can be measured.

The rotation unit 140 can be configured to rotate the signal transmission unit 110 and the signal transmission 120. In this case, however, since the signal transmission unit 110 and the signal reception unit 120 are electrical devices, wiring becomes complicated. In addition, wires may be twisted by the rotation of the signal transmission unit 110 and the signal reception unit 120. For this reason, a reflective mirror (not shown) is usually used.

The reflective mirror (not shown) is located in front of the signal transmission unit 110 to reflect the signal transmitted from the signal transmission unit 110 at a certain angle. Since the reflective mirror (not shown) is rotatable, it can adjust the angle at which it reflects the signal transmitted from the signal transmission unit 110. Therefore, when the reflective mirror (not shown) is rotated at a predetermined speed, the signal output from the signal transmission unit 110 and proceeding straight may be transmitted by being rotated at the predetermined.

The technology of rotating the direction of a signal transmitted from the signal transmission unit 110 using the reflective mirror (not shown) is a known technology, and thus a detailed description thereof will be omitted.

To generate an obstacle map by measuring distances to obstacles while a mobile robot is travelling, the direction in which the rotary type distance estimation apparatus 100 measured the distance to each obstacle needs to be identified. In addition to information about the direction and position of the mobile robot, the direction of the rotary type distance estimation apparatus 100 relative to the mobile robot (more accurately, the direction in which a signal transmitted from the signal transmission unit 110 proceeds to each obstacle) should be identified. Only then, the direction of each obstacle can be identified, and the entire obstacle map can be generated based on the distances between the mobile robot and the obstacles whose directions have been identified.

The determination unit 150 identifies a direction in which a signal output from the signal transmission unit 110 proceeds to an obstacle. To this end, while a signal is transmitted to obstacles by continuously rotating the direction of the signal using the rotation unit 140, the determination unit 150 may sample the signal received by the signal reception unit 120 at predetermined sampling time. Then, the determination unit 150 may identify an angle by which a transmission direction of the signal is rotated at each sampling (hereinafter, referred to as a rotation angle per sampling) based on the number of times that the signal received by the signal reception unit 120 is sampled. For example, when a laser signal can be received within a 100-degree range, if the received laser signal is sampled 1,000 times while the laser signal rotates within the 100-degree range, the rotation angle per sampling may be 0.1 degrees. Therefore, if n samplings were conducted at a certain location, it can be understood that a laser signal has been rotated by 0.1n with respect to the location. Therefore, in the present invention, a rotation angle per sampling is calculated using the number of times that a signal received by the signal reception unit 120 is sampled while the signal is transmitted within a predetermined angle range, and the direction of the signal can be determined based on the calculated rotation angle per sampling.

In FIG. 4, the mobile robot 300 seen from the ceiling is illustrated. Referring to FIG. 4, the rotary type distance estimation apparatus 100 is generally installed on a front surface of the mobile robot 300. Therefore, as the reflective mirror rotates 360 degrees, it reflects signals output from the signal transmission unit 110 in a 360-degree direction. Of the received signals, data received at a certain range of angles may be data reflected by the mobile robot 300.

In the present invention, when signals are transmitted and received by being rotated 360 degrees by the rotation unit 140, a range of angles at which light reflected by external obstacles is received may be referred to as an effective angle range, and a range of angles at which light reflected by the mobile robot 300 is received may be referred to as an ineffective angle range. Here, when signals transmitted from the signal transmission unit 110 and reflected in a 360-degree direction are received, if data is continuously received from an ultra-short distance at certain intervals, it may be determined to be signals reflected by the mobile robot 300, and the ineffective angle range may be determined.

In addition, a pattern of signals received after being reflected by the mobile robot 300 may be stored in advance. Then, when a pattern of signals similar to the stored pattern are received, the ineffective angle range may be determined. In FIG. 4, an effective angle range of 180 degrees is formed in front of the mobile robot 300, and an ineffective angle range of 180 degrees is formed behind the mobile robot 300. The ineffective angle range can be only one point, depending on the installation position of the rotary type distance estimation apparatus 100. In this case, the rotary type distance estimation apparatus 100 can measure distances to obstacles in a 360-degree direction.

Therefore, when signals are transmitted and received by being continuously rotated 360 degrees by the rotation unit 140, since the effective angle range and the ineffective angle range are repeated alternately, the range of angles at which effective signals reflected by external obstacles are received and the range of angles at which ineffective signals reflected by the mobile robot 300 are received are repeated alternately.

Referring to FIG. 5, when a signal for measuring the distance to an obstacle is transmitted by being rotated in a counterclockwise direction, the determination unit 150 starts to count the number of times that the signal is sampled from a point where the effective angle range (a 180-degree range in front) begins and the ineffective angle range (a 180-degree range in the rear) ends and multiplies the counted number of times by the above-described rotation angle per sampling. In this way, the determination unit 150 can calculate the rotation angle of the signal from a boundary between the ineffective angle range and the effective angle range. Here, the rotation angle per sampling may be a value calculated and input in advance. Otherwise, the rotation angle per sampling may be calculated using the above-described method by rotating the signal a plurality of times using the rotation unit 140 before actually measuring the distance to an obstacle.

As shown in FIG. 5, an angle of a signal transmitted to measure the distance to an obstacle can be determined to be αusing the above-described method.

In the present invention, the memory unit 160 storing a value of data received by the signal reception unit 120 may further be provided. The memory unit 160 may also store a transmission angle of a signal which corresponds to each data value and is calculated by the determination unit 150.

A map generation unit 200 may generate an obstacle map using values stored in the memory unit 160.

A case where the rotary type distance estimation apparatus 100 according to the current exemplary embodiment of the present invention is installed in a mobile robot has been described above as an example. However, the present invention is not limited to this example. The rotary type distance estimation apparatus 100 can also be installed in a moving body. For example, the rotary type distance estimation apparatus 100 can be installed in a vehicle to seize the movement of traffic ahead. In addition, the rotary type distance estimation apparatus 100 can be installed in a fixed body, instead of a moving body.

A rotary type distance estimation apparatus and a moving body including the same according to the present invention provide at least one of the following advantages.

First, a direction in which a signal is transmitted can be identified without installing an additional device such as an encoder in the rotary type distance estimation apparatus.

Second, since no additional device such as an encoder is required, equipment cost can be reduced.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A rotary type distance estimation apparatus comprising:
a signal transmission unit transmitting a signal for measuring a distance to an obstacle;
a signal reception unit receiving the signal reflected by the obstacle;
a distance calculation unit calculating the distance to the obstacle by processing the received signal;
a rotation unit rotating a direction of the signal transmitted from the signal transmission unit; and
a determination unit determining the direction of the signal within a predetermined angle range according to what number of times the received signal matches based on a rotation angle per sampling of the signal.

2. The apparatus of claim 1, wherein the signal comprises any one of a laser signal, an infrared signal, and an ultrasonic signal which are a straight signal.

3. The apparatus of claim 1, wherein the signal reception unit receives the signal reflected by the obstacle at predetermined intervals.

4. The apparatus of claim 1, wherein the rotation unit comprises a reflective mirror which is located in front of the signal transmission unit and is rotatable to reflect the signal transmitted from the signal transmission unit at a predetermined angle.

5. The apparatus of claim 4, wherein while the reflective mirror rotates 360 degrees, the determination unit counts the number of times that the signal is sampled from a point where an effective angle range begins and an ineffective angle range ends and multiples the counted number of times by the rotation angle per sampling to determine the direction of the signal, wherein the effective angle range is a range of angles at which signals reflected by external obstacles whose distances from the apparatus are to be measured are received, and the ineffective angle range is a range excluding the effective angle range.

6. A moving body comprising a sensor which senses obstacles and generating an obstacle map while autonomously travelling around, wherein the sensor comprises:
a signal transmission unit transmitting a signal for measuring a distance to an obstacle;
a signal reception unit receiving the signal reflected by the obstacle;
a distance calculation unit calculating the distance to the obstacle by processing the received signal;
a rotation unit rotating a direction of the signal transmitted from the signal transmission unit; and
determining unit for determining the direction of the signal within a predetermined angle range according to what number of times the received signal matches based on a rotation angle per sampling of the signal.

7. The moving body of claim 6, wherein the sensor is installed in front of the moving body.

8. The moving body of claim 6, wherein the signal comprises any one of a laser signal, an infrared signal, and an ultrasonic signal which are a straight signal.

9. The moving body of claim 6, wherein the signal reception unit receives the signal reflected by the obstacle at predetermined intervals.

10. The moving body of claim 6, wherein the rotation unit comprises a reflective mirror which is located in front of the signal transmission unit and is rotatable to reflect the signal transmitted from the signal transmission unit at a predetermined angle.

11. The moving body of claim 10, wherein while the reflective mirror rotates 360 degrees, the determination unit counts the number of times that the signal is sampled from a point where an effective angle range begins and an ineffective angle range ends and multiples the counted number of times by the rotation angle per sampling to determine the direction of the signal, wherein the effective angle range is a range of angles at which signals reflected by external obstacles whose distances from the moving body are to be measured are received, and the ineffective angle range is a range excluding the effective angle range.
